(19) United States
(12) Patent Application Publication
(10) Pub. No.: US 2002/0059134 A1
(43) Pub. Date: May 16, 2002

(54) Flexible and extensible e-commerce architecture

(75) Inventors: Kenneth Ebbs, Los Altos, CA (US); Tuan Tran, Milpitas, CA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Sun Microsystems, Inc.

(21) Appl. No.: 09/987,760

(22) Filed: Nov. 15, 2001

Related U.S. Application Data
(60) Provisional application No. 60/248,251, filed on Nov. 15, 2000.
(60) Provisional application No. 60/251,886, filed on Dec. 8, 2000.

(51) Int. Cl. G06F 17/60

(52) U.S. Cl. 705/37; 705/26

(57) ABSTRACT

The invention provides a flexible, extensible and customizable architecture for supporting e-commerce applications. The system allows the integration of extensible modules with a software bus providing access to common e-commerce services. Thus, the invention eliminates the need for creating a custom architecture for supporting desired services.

### CROSS REFERENCE TO RELATED APPLICATIONS

This application claims benefit of U.S. Provisional Application No. 60/248,251, filed on Nov. 15, 2000, and U.S. Provision Application No. 60/251,886, filed on Dec. 8, 2000, both of which are entitled: FLEXIBLE AND EXTENSIBLE E-COMMERCE ARCHITECTURE, and both of which are hereby incorporated by reference.

### BACKGROUND OF THE INVENTION

1. Field of the Invention

The invention relates to an overall architecture for e-commerce applications. More specifically, the invention provides a system including a customizable software bus that supports multiple extensible e-commerce modules.

2. Discussion of the Related Art

The emergence of the World Wide Web (WWW) and the Internet has provided a new medium for conducting communications and transactions. The Internet can support on-line communications as well as provide a common marketplace for viewing, purchasing and/or auctioning goods and services.

Thus, many known functions, including information gathering, retail sales, commercial transactions, business inventory management, just to name a few, may now be conducted on-line over the Internet.

Conventional e-commerce services are not built on a common and extensible platform that can be deployed in a variety of environments. Instead, conventional platforms provide tool kits and suites of e-commerce APIs. As a result, someone seeking to establish an e-commerce site or application over the Internet needs to develop a customized architecture capable of supporting the desired applications. For example, someone wanting to set up an on-line auction that is capable of supporting negotiation between parties, capable of accepting on-line payment, and capable of providing on-line notification to the auction winners, needs to develop a customized architecture that includes the appropriate interfaces between services. The resulting customized solution cannot be used outside of the particular marketplace, and is bound to both a single deployment platform and a single architecture (i.e., EJB but not servlets and visa versa).

The present invention solves this problem by providing an out-of-the-box, end-to-end marketplace platform that provides commonality across all components of the product and allows for extensibility that is not possible in other market place platforms.

### SUMMARY OF THE INVENTION

The conventional systems described above do not provide a common architecture capable of supporting custom services. Instead, significant time and effort must be spent to develop a customized architecture that can support the selected services. Thus, most conventional systems are bound to a single architecture.

The invention overcomes the problems of conventional systems by providing an out-of-the-box e-commerce architecture that provides a flexible, customizable, software bus that enables extensible modules to access a plurality of common e-commerce services. These extensible modules include auction, catalog, pricing, negotiation, community, exchange, and order management (OMS) modules. The common e-commerce services include data access, notification, internationalization, auditing, reporting, configuration, transaction, query assistant, attachments, exception handling, and security services.

The architecture according to the invention is scalable and can be deployed on multiple platforms and can interface with many services. In addition, the architecture according to the invention can support newly-developed modules, including third party modules, with known services. The architecture is capable of running EJB (Enterprise Java® Bean) and non-EJB specifications.

Thus, the invention provides a flexible, extensible, scalable and customizable platform for e-commerce applications comprising a customizable presentation framework for receiving data from a server and communicating the data to a plurality of extensible modules. Each of the plurality of extensible modules is communicatively connected to the customizable presentation framework and to a software bus. The software bus is also communicatively connected to a plurality of services, thereby enabling communication between the plurality of extensible modules and the plurality of services.

In a further embodiment, the invention provides an extensible module for performing e-commerce functions that include a manager object, a plurality of fine grain objects and a remotable object. The manager object receives data from a customizable presentation framework connected to a server and dynamically generates the plurality of fine grain objects. The plurality of fine grain objects are passed as parameters to the remotable object, which performs actions on behalf of the plurality of fine grain objects.

In an alternate embodiment, the invention includes a software bus that provides a plurality of services to a plurality of extensible modules. The software bus comprises a standard interface for providing access to the plurality of extensible modules, a service interface for providing common access to the plurality of services, and a server independent communication means for enabling communication between the plurality of extensible modules and the plurality of services.

In a further embodiment, the invention provides a method of providing a flexible, extensible, customizable platform for e-commerce applications. This method includes the steps of inputting data to a customizable presentation framework which is communicatively connected to a plurality of extensible modules, selecting actions to be performed on the data and implemented by the plurality of extensible modules, and accessing a plurality of services via an interface between the plurality of extensible modules and a software bus. The software bus is also communicatively coupled to the plurality of services.

Additional features and advantages of the invention will be set forth in the description that follows, and in part will be apparent from the description, or may learned from the practice of the invention. The advantages of the invention will be realized and attained by the structure described in the written description and claims hereof as well as illustrated by the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows the major components of the architecture according to an embodiment of the invention;

FIG. 2 is a block diagram illustrating one embodiment of the architecture according to the invention;

FIG. 3 is a block diagram illustrating an alternate embodiment of the architecture according to the invention;

FIG. 4 is a block diagram illustrating the content of an extensible module according to the invention; and

FIG. 5 illustrates a method for establishing services according to an embodiment of the invention.

### DETAILED DESCRIPTION OF THE PREFERRED EMBODIMENTS

Reference will now be made in detail to the preferred embodiments of the invention, examples of which are illustrated in the drawings.

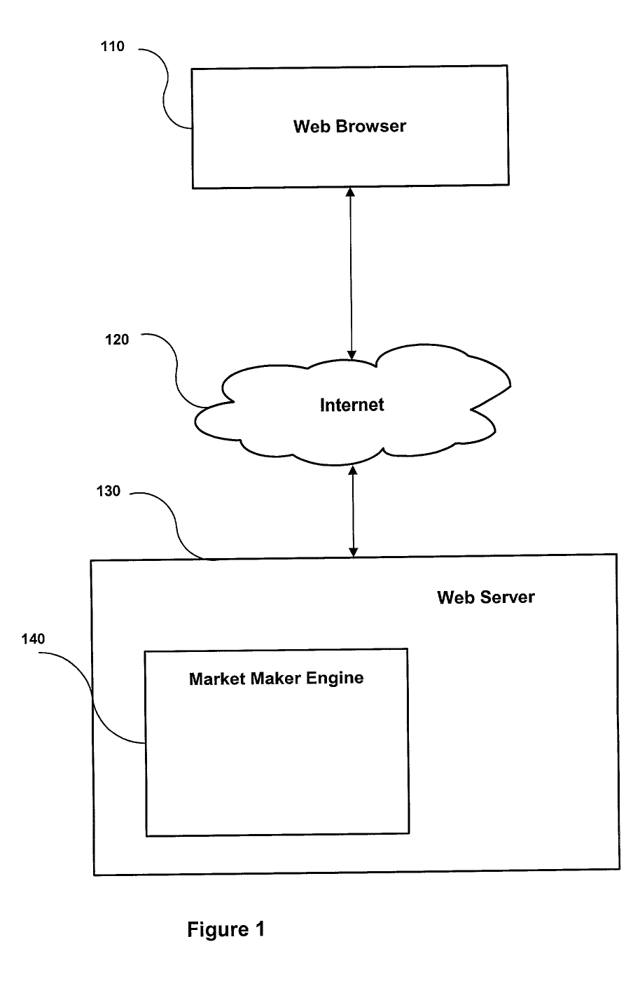

FIG. 1 is a block diagram illustrating the architecture according to an embodiment of the invention. FIG. 1 shows a web browser 110 coupled to a web server 130 via a network connection such as, but not limited to the Internet 120. In one embodiment, a firewall may reside between the network connection and the web server 130. The web browser 110 may be any one of a number of known web browsers, such as a Netscape® browser, installed on any number of known network devices, such as a personal computer. The web server 130 may hold any number of services and engines, including for example a Java® Page Server Engine capable of supporting web pages. The web server 130 may include a J2EE compliant Servlet engine (e.g., running in the iPlanet Web Server or iPlanet Application Server) and a J2EE Enterprise Java Bean application server. A market maker engine 140 in accordance with the invention resides on the web server 130. The market maker engine 140 according to the invention includes the extensible architecture according to the invention. Thus, the market maker engine 140 provides an architecture capable of supporting both extensible modules and common services required for e-commerce applications.

In operation, the market maker engine 140 can be configured for desired extensible modules. These modules will be fully integrated with common e-commerce services. A user can access the e-commerce applications from a network device using the web browser 110. The web browser will access the web server 130 through which the user may access the applications supported by the market maker engine 140. In one embodiment, the user will be provided a graphical user interface for selecting desired applications.

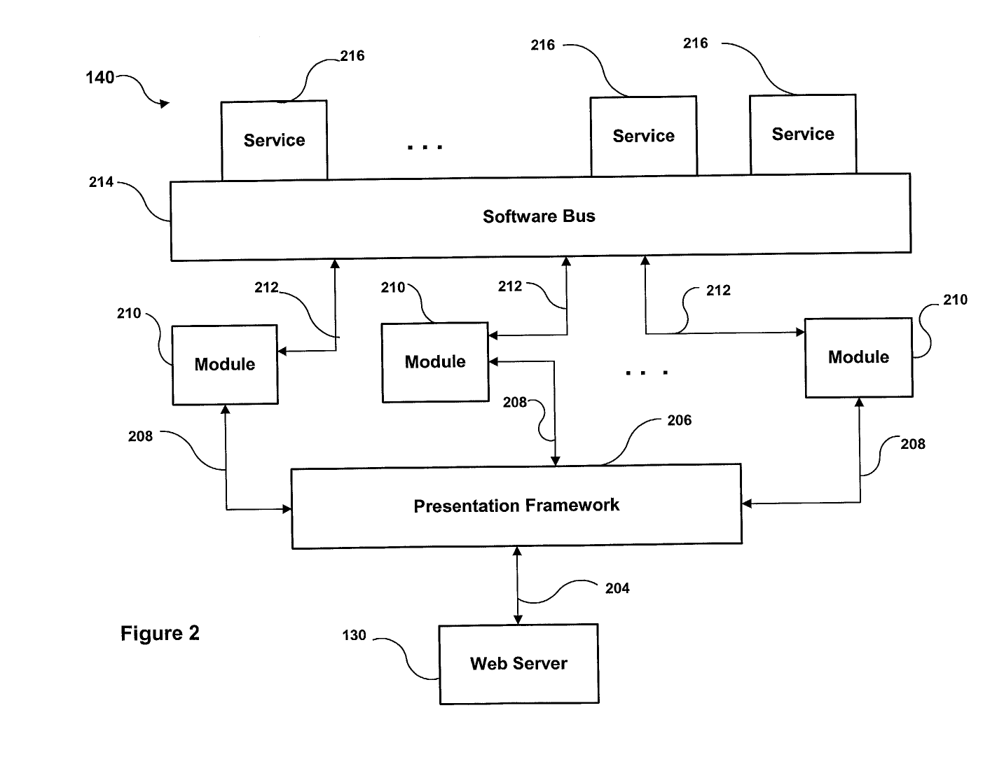

FIG. 2 shows the market maker engine 140 of FIG. 1 in greater detail. FIG. 2 illustrates that the market maker engine 140 includes a customizable presentation framework 206, a plurality of extensible modules 210, a software bus 214, and a plurality of services 216. The customizable presentation framework 206 allows a user to access and input data to the market maker engine 140 via the web server 130. The web server 130 is connected to the customizable presentation framework 206, of the market maker engine 140, via an interface 204. The customizable presentation framework 206 is communicatively connected to the plurality of modules 210 via an interface 208. In one embodiment, the customizable presentation framework 206 operates independently from the plurality of extensible modules 210 and the software bus 214.

The plurality of extensible modules 210 provide e-commerce functions. These modules include auction, catalog, pricing, negotiation, community, exchange, order management (OMS), and other user-defined components or functions.

The auction module provides support for multiple forward and reverse auctions. In an auction, the bidder is obligated to purchase the items, unlike in a negotiation process, when a buyer can decide not to purchase the items. Forward auctions may enable a minimum price to be set by a seller, and buyers can outbid each other until the auction closes; highest bidder being the winner. The forward auctions may be initiated by a selling company. Reverse auctions may enable a buyer to specify an item wanted, and sellers bid on the item; lowest bidder being the winner. Reverse auctions may be initiated by a buying company. Many auction parameters are supported by the auction module including proxy bidding, on/off catalog items, bid extension, invitation only, favorites, delayed start and automated time based closure, anonymous, and ownership at a company level.

The catalog module provides aggregation and normalization of catalog data. The market maker engine 140 defines the normalization rules. Catalog items may be searchable in the catalog module based on required attributes, searchable attributes, and optional attributes. Catalog listings may be created off-line by using an import process, and on-line via a browser. Private catalogs may be created that control the catalog items that a particular user or group of users have access to purchase. Catalog items may be turned into forward auction, reverse auction, and negotiation items.

The pricing module provides simple and complex pricing rules and agreements between a seller and at least one buyer. On the seller's side, selling companies may create pricing rules between their company and other companies or buying clubs. These rules may be per product or product category. On the buyer's side, buying companies may be notified when they are affected by a pricing rule and must approve the rule before it takes affect.

The negotiation module provides end-to-end RFx capabilities, including RFP (Request for Proposal), RFI (Request for Information), and RFQ (Request for Quote). Buyers have the ability to create an online request (RFI, RFQ, RFP) comprising on and/or off catalog items. Buyers are also able to quickly analyze all responses, revise requests, clone requests, reward responders, create distribution lists, and open reverse auctions. Sellers are able to respond online to requests, clone a response, revise responses and take ownership of requests.

The community module provides company and user management, as well as community services including instant messaging. The community module integrates the plurality of services 216. The community module also enables a plurality of functions including single sign-on across the plurality of extensible modules, user and company registration, and delegated administration.

The exchange module provides an extensible, fault-tolerant, scalable bid/ask trading platform enabling multi-attribute matching of commoditized products and services. The exchange module is a liquid outlet for distribution or procurement of products and services, as both buyers and sellers may asynchronously trade homogenous commodities in real time. Value is created by temporal matching of supply and demand. The Exchange module is able to specify matching attributes particular to an Exchange beyond price and quantity. That is, the criteria used for order matching is completely arbitrary and customizable, enabling the Exchange host to easily develop sophisticated matching rules for industry-specific exchanges. For example, quality of service or preferred vendors may be incorporated into the order matching criteria. Features of the exchange module may also include a high performance, multi-attribute, asynchronous matching engine, swappable exchange services, close attribute matching, real-time price determination, manual matching, market-wide member blacklisting, order splitting, exchange management, and symbol suspension.

The order management (OMS) module provides online requisition and purchase order creation as well as approval. On the buyer's side, the OMS module provides services including support for requisitions (e.g., catalog, auctions, RFx), support for requisition approval, and work in progress support. On the seller's side, a selling company can accept or reject an entire purchase order online.

In FIG. 2, each of the plurality of extensible modules 210 is packaged independently and directly connected to the software bus 214. Each of the plurality of extensible modules 210 may be added to or removed from the software bus 214. This ability allows each module to be used in isolation, or tightly integrated, depending on the presence or absence of a module. For example, if the auction module is present, the negotiation module may contain processes to transform a Request for Quote (RFQ) automatically into a reverse auction.

The extensibility of these modules enables them to perform functions for a broad range of e-commerce applications. For example, the community module may keep track of community membership or members of a group, irrespective of the size of the group. The catalog module provides an extensible listing or log of goods and services. The pricing module determines prices for e-commerce transactions or even auction applications, regardless of the size of the transaction or application. The negotiation module provides support for an online negotiation, regardless of the number of negotiators. The auction module provides the format and rules governing many different auction formats. The party establishing the e-commerce application can select among the offered modules. All of the user-defined services may reside in the plurality of extensible modules 210.

In one embodiment, the plurality of extensible modules 210 are all structured around a common set of design patterns and integrated into the software bus 214, via an interface 212. This commonality provides symmetry across the extensible modules. The software bus 214 is communicatively coupled to a plurality of services 216 common to any e-commerce application. The software bus 214 provides the plurality of extensible modules 210 common access to the plurality of services 216.

In one embodiment, the software bus 214 includes a standard interface for providing access to the plurality of extensible modules 210, a service interface for providing common access to the plurality of services 216 across the plurality of extensible modules 210, and a server-independent communication means for coordinating communication between the plurality of extensible modules 210 and the plurality of services 216. The plurality of services 216 deliver functionality shared by the plurality of extensible modules. The plurality of services 216 may include data access, auditing, notification, internationalization, reporting, configuration, transaction, query assistant, attachments, exception handling, and security services.

The data access service allows the system to access data from a storage location. The data may be stored in an Oracle or other type of database.

The market maker engine 140 supports multiple levels of auditing. The auditing service provides the capability of maintaining a transactional audit trail of business events. The auditing service may provide information including what information gets recorded, who performed the operation, and how the recorded information is retrieved/analyzed. The auditing information may also be used to establish financial transaction fee services. In one embodiment, the auditing service may enable introspection of the information to provide cost-based services requested by buying and selling organizations.

The notification service allows user-configurable types of notifications including e-mail, inbox, and AIM (AOL Instant Messenger®). The notification service may be configured to occur for significant events, such as when a new auction is posted or when a purchase order is received. In one embodiment, a notification may comprise the text of the notification message and any URLs that are included in the message text.

The internationalization service enables currency conversion, date and time information, and other localized properties. The reporting service is capable of providing reports based upon the services requested. The configuration service provides persistence and maintenance of configuration information. The transaction service provides support for client and/or server initiated transactions. The query assistant service provides an infrastructure for object querying. The attachments service provides the ability to attach arbitrary documents. The exception handling service provides debugging capabilities and a tracing framework. The security service provides the ability to register resources and actions, and to perform access control checks, JCE crypto APIs.

In operation, from the business logic side, an e-commerce provider may select which of the plurality of extensible modules 210 to employ in the e-commerce application. For example, if the e-commerce provider is providing an auction platform, the auction module, negotiation module, pricing module, and catalog module may be selected. Each of these extensible modules is plugged in to the software bus 214, thereby having common access to the plurality of services 216 available through the software bus 214. The plurality of services 216 may include auditing, data access, notification and reporting services. For example, using the auditing service, the auction module is able to maintain a log of selected bids and auction items. The negotiation module may also use the auditing service to maintain a log including RFQs, RFIs, and RFPs. The cataloging module may utilize the data access service to access catalog items stored in a database.

In operation, from the presentation logic side, a user may select e-commerce functions via the customizable presentation framework 206. For example, a user seeking to bid on an auction item, may select the display accessing the auction module. The auction module performs the requested action on the data received from the user. The notification service 216, which is accessed by the auction module via the software bus 214, then returns a message to the user that the requested action has been performed. In one embodiment, the customizable presentation framework 206 is independent of the business logic and is the only component of the marker maker engine 140 that is session aware.

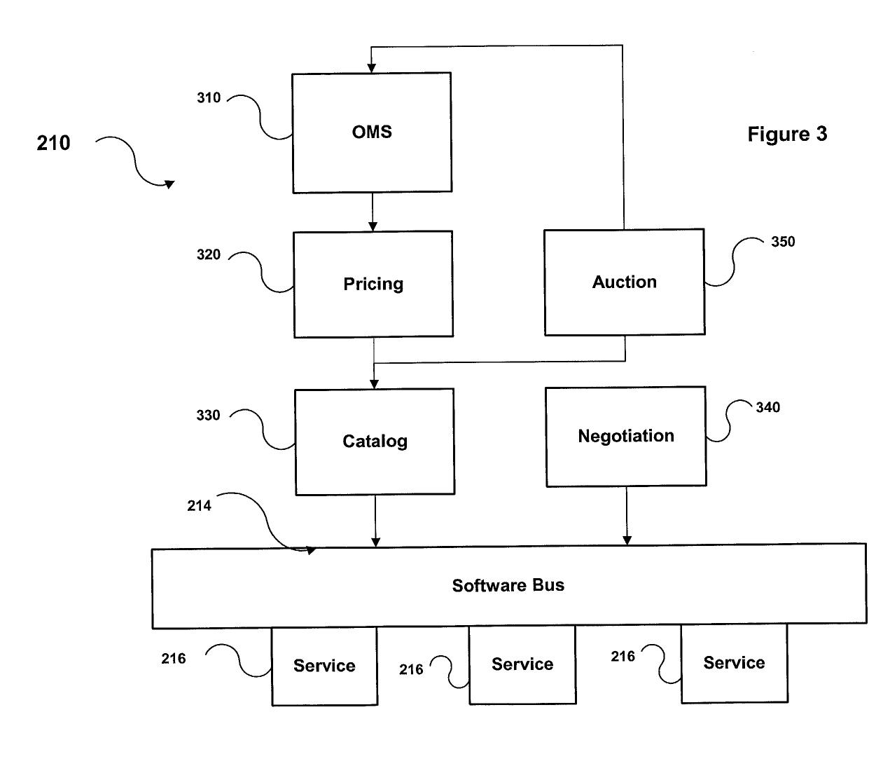

FIG. 3 illustrates an embodiment of the architecture wherein each of the plurality of extensible modules 210, also shown in FIG. 2, may depend upon any other of the plurality of extensible modules for communication with the software bus 214. As in FIG. 2, the software bus 214 is communicatively coupled to a plurality of services 216 common to an e-commerce application. The software bus 214 provides the plurality of extensible modules 210 common access the plurality of services 216. Unlike FIG. 2, wherein each of the plurality of extensible modules 210 is packaged independently and directly connected to the software bus 214, in FIG. 3, four of the five extensible modules are packaged together. The catalog module 330 is directly connected to the software bus 214, and the OMS module 310, pricing module 320, and auction module 350 depend upon the catalog module 330 for communication with the software bus 214. Specifically, the pricing module 320 is communicatively connected to the catalog module 330, which is communicatively connected to the software bus 214. The OMS module 310 is communicatively connected to the pricing module 320, which is communicatively connected to the catalog module 330, which is communicatively connected to the software bus 214. The auction module 350 is communicatively connected to the catalog module 330, which is communicatively connected to the software bus 214. Thus, the catalog module 330, pricing module 320, OMS module 310, and Auction module 350 are packaged together. The negotiation module 340 is packaged independently and is communicatively connected to the software bus 214.

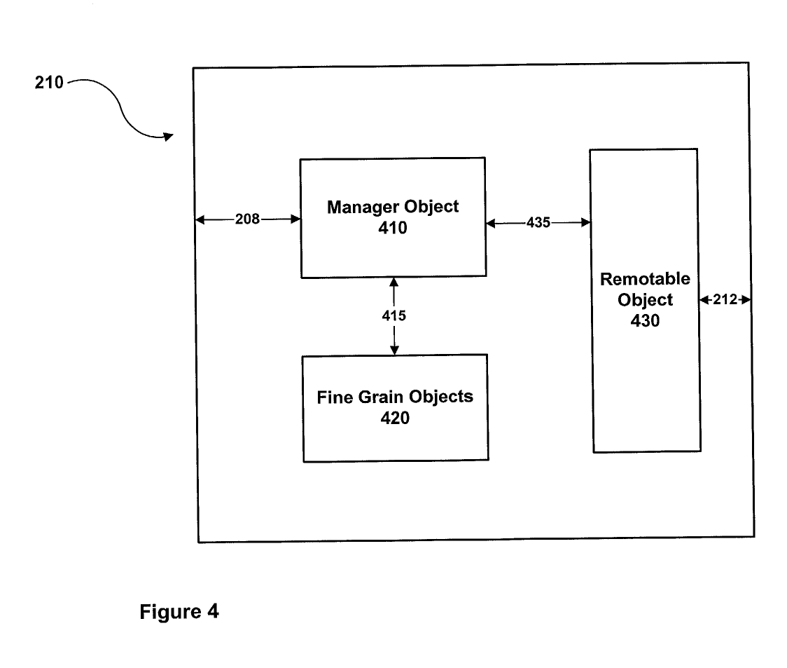

FIG. 4 shows the components of the plurality of modules 210. Each of the plurality of modules 210 includes a manager object 410, a plurality of fine grain objects 420 and a remotable object 430.

The manager object 410 is created by the customizable presentation framework 206. The manager object 410 allows access to the fine grain objects 420 and is typically the point of access for a given module. Specifically, the manager object 410 is communicatively connected to the customizable presentation framework 206 by the interface 208. The manager object is communicatively connected to the plurality of fine grain objects 420 via interface 415, and to the remotable object 430 via interface 435. Thus, the manager object 410 has contact with both the presentation logic and the server side business logic. The manager object 410 provides functionality, such as generating the plurality of fine grain objects 420 and the remotable object 430. In one embodiment, the manager object 410 may be stateless.

The fine grain objects 420 are generated by the manager object 410, and are passed as parameters to the remotable object 430 via the manager object 410. The fine grain objects 420 include light-weight objects that represent the data utilized by each of the plurality of modules 210. For example, the auction module 350, shown in FIG. 3, may contain fine grain objects 420 representing bids and auction items. The negotiation module 340, shown in FIG. 3, may contain fine grain objects 420 representing RFx requests and RFx responses (e.g., bids and quotes). The catalog module 330, shown in FIG. 3, may contain fine grain objects 420 representing catalog items. The community module may contain fine grain objects 420 representing users, groups, and resources. The pricing module 320, shown in FIG. 3, may contain fine grain objects 420 representing trading agreements. The OMS module 310, shown in FIG. 3, may contain fine grain objects 420 representing requisitions. In one embodiment, the plurality of fine grain objects 420 include persistent objects.

The remotable object 430 includes one or more coarse stateless objects. The plurality of fine grain objects 420 rely on the remotable object 430 to populate or perform actions upon themselves. The actions performed by the remotable object 430 on behalf of the fine grain objects 420 may include submit, revise, cancel, and close. In one embodiment, the remotable object does not coexist in the same physical location as the plurality of fine grain objects 420. The remotable object 430 may be implemented as an object including an EJB, a Corba object and a Java® object. In one embodiment, the remotable object 430 may be implemented as a stateless, session bean. The remotable object 430 is communicatively connected to the software bus 214 via the interface 212.

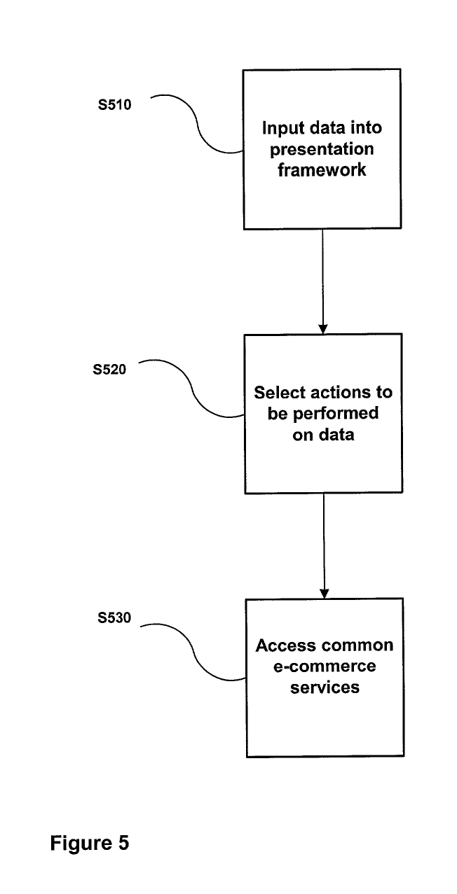

FIG. 5 is a flow chart illustrating the process, in accordance with one embodiment of the invention, by which a business event is established. In FIG. 5, the process begins with step S510. In step S510, data is input to the customizable presentation framework 206. In one embodiment, a user accesses the customizable presentation framework 206 on a web browser 110 coupled to a web server 130 via a network connection such as, but not limited to, the Internet 120. The customizable presentation framework 206 is communicatively coupled to the plurality of extensible modules 210 via an interface 208 with the manager object 310 contained in each of the plurality of extensible modules 210. In one embodiment, the customizable presentation framework 206 operates independently from the plurality of extensible modules 210 and the software bus 214. The process then moves to step S520.

In step S520, actions are selected to be performed on the data. The selected actions are implemented by the plurality of extensible modules 210. In one embodiment, the selected actions may be implemented by passing the data and at least one of the plurality of fine grain objects 420 to the remotable object 430. The selected actions may include submit, revise, cancel, and close. The process then moves to step S530.

In step S530, the plurality of e-commerce services 216 are accessed via an interface 212 between the plurality of extensible modules 210 and the software bus 214. The software bus 214 is communicatively connected to the plurality of services 216 and provides each of the plurality of extensible modules 210 common access to the services 216. The plurality of services may include data access, auditing, notification, internationalization, reporting, configuration, transaction, query assistant, attachments, exception handling, and security services.

It will be apparent to those skilled in the art that various modifications and variations can be made in the system of the present invention without departing from the spirit or scope of the invention. Thus, it is intended that the present invention cover the modifications and variations of this invention provided that they come within the scope of any claims and their equivalents.

We claim:

1. A system for providing a flexible, extensible, customizable platform for e-commerce applications comprising:
a customizable presentation framework for receiving data from a server and communicating the data to a plurality of extensible modules;
a plurality of extensible modules, each module communicatively connected to a software bus and to the customizable presentation framework; and
a software bus communicatively coupled to a plurality of services, the software bus enabling communication between the plurality of extensible modules and the plurality of services.

2. The system according to claim 1, wherein the server is a J2EE compliant servlet engine.

3. The system according to claim 1, wherein the server is a J2EE Enterprise Java Bean application server.

4. The system according to claim 1, wherein each module includes a manager object for interfacing with the customizable presentation framework.

5. The system according to claim 1, wherein the plurality of extensible modules includes at least one of an auction module, a catalog module, a pricing module, a negotiation module, a community module, an exchange module, and an order management (OMS) module.

6. The system according to claim 1, wherein each module further includes a plurality of fine grain objects, the fine grain objects representing data utilized by the module.

7. The system according to claim 6, wherein the fine grain objects include persistent objects.

8. The system according to claim 1, wherein each module further includes a remotable object which interfaces with the software bus.

9. The system according to claim 8, wherein the remotable object includes a stateless session bean.

10. The system according to claim 1, wherein the plurality of services include at least one of data access, notification, internationalization, auditing, reporting, configuration, transaction, query assistant, attachments, exception handling, and security.

11. The system according to claim 1, wherein each of the plurality of extensible modules may be packaged independently and communicatively connected to the software bus.

12. The system according to claim 11, wherein each of the plurality of modules includes a notification module.

13. The system according to claim 1, wherein each of the plurality of extensible modules may depend upon any other of the plurality of extensible modules for communication with the software bus.

14. The system according to claim 13, wherein each of the plurality of modules includes at least one of a catalog module, a pricing module, an OMS module, and an auction module.

15. The system according to claim 14, wherein the catalog module is communicatively connected to the software bus, the pricing module is communicatively connected to the catalog module, the OMS module is communicatively connected to the pricing module, and the auction module is communicatively coupled to the catalog module.

16. An extensible module for performing e-commerce functions comprising:
a manager object for receiving data from a customizable presentation framework connected to a server;
a plurality of fine grain objects which are dynamically generated by the manager object and are passed as parameters to a remotable object; and
a remotable object for performing actions on behalf of the fine grain objects and interfacing with a software bus, the software bus enabling communication between the extensible module and a plurality of services.

17. The extensible module according to claim 16, wherein the plurality of fine grain objects include persistent objects.

18. The extensible module according to claim 16, wherein the plurality of fine grain objects represent data used by the extensible module.

19. The extensible module according to claim 16, wherein the remotable object includes a stateless session bean.

20. The extensible module according to claim 16, wherein the plurality of services include at least one of data access, notification, internationalization, auditing, reporting, configuration, transaction, query assistant, attachments, exception handling, and security.

21. The extensible module according to claim 16, wherein the extensible module is an auction module.

22. The extensible module according to claim 21, wherein the plurality of fine grain objects include bids and auction items.

23. The extensible module according to claim 16, wherein the extensible module is a negotiation module.

24. The extensible module according to claim 23, wherein the plurality of fine grain objects include bids and quotes.

25. The extensible module according to claim 16, wherein the extensible module is a catalog module.

26. The extensible module according to claim 25, wherein the plurality of fine grain objects include catalog items.

27. The extensible module according to claim 16, wherein the extensible module is a community module.

28. The extensible module according to claim 27, wherein the plurality of fine grain objects include users, groups and resources.

29. The extensible module according to claim 16, wherein the extensible module is a pricing module.

30. The extensible module according to claim 29, wherein the plurality of fine grain objects include trading agreements.

31. The extensible module according to claim 16, wherein the extensible module is an exchange module.

32. The extensible module according to claim 16, wherein the extensible module is an order management (OMS) module.

33. The extensible module according to claim 32, wherein the plurality of fine grain objects include requisitions.

34. A software bus for providing a plurality of services to a plurality of extensible modules comprising:
a standard interface for providing access to the plurality of extensible modules;
a service interface for providing common access to the plurality of services; and
a server independent communication means for enabling communication between the plurality of extensible modules and the plurality of services.

35. The software bus according to claim 34, wherein the plurality of modules include at least one of an auction module, a catalog module, a pricing module, a negotiation module, a community module, an exchange module, and an order management (OMS) module.

36. The software bus according to claim 34, wherein the each of the plurality of modules can be added or removed from the software bus.

37. The software bus according to claim 34, wherein the plurality of services include at least one of data access, notification, internationalization, auditing, reporting, configuration, transaction, query assistant, attachments, exception handling, and security.

38. A method of providing a flexible, extensible, customizable platform for e-commerce applications comprising the steps of:
inputting data to a customizable presentation framework, the customizable presentation framework communicatively connected to a plurality of extensible modules;
selecting actions to be performed on the data, the selected actions implemented by the plurality of extensible modules; and
accessing a plurality of services via an interface between the plurality of extensible modules and a software bus, the software bus communicatively coupled to the plurality of services.

39. The method according to claim 38, wherein the customizable presentation framework is connected to the plurality of extensible modules via an interface with a manager object contained in each of the plurality of extensible modules.

40. The method according to claim 38, wherein the customizable presentation framework operates independently from the plurality of extensible modules and the software bus.

41. The method according to claim 38, wherein the selected actions are implemented by passing the data and at least one of a plurality of fine grain objects to a remotable object located in each of the plurality of extensible modules.

42. The method according to claim 38, wherein the plurality of extensible modules include at least one of an auction module, a catalog module, a pricing module, a negotiation module, a community module, an exchange module, and an order management (OMS) module.

43. The method according to claim 41, wherein the plurality of fine grain objects include persistent objects.

44. The method according to claim 41, wherein the remotable object includes a stateless session bean.

45. The method according to claim 38, wherein the selected actions include at least one of submit, revise, cancel, and close.

46. The method according to claim 38, wherein the plurality of services include at least one of data access, notification, internationalization, auditing, reporting, configuration, transaction, query assistant, attachments, exception handling, and security.
